(19) United States
(12) Patent Application Publication
(10) Pub. No.: US 2009/0130362 A1
(43) Pub. Date: May 21, 2009

(54) MULTIUSE DRY ERASE WRITING AND PROJECTION SURFACE

(75) Inventor: Jim Egan, Woodbridge (CA)

Correspondence Address: BERESKIN AND PARR, 40 KING STREET WEST, BOX 401, TORONTO, ON, M5H 3Y2, CA

(73) Assignee: EGAN VISUAL INC., Woodbridge (CA)

(21) Appl. No.: 11/944,141

(22) Filed: Nov. 21, 2007

(51) Int. Cl. B32B 33/00; B32B 7/02; B32B 7/14

(52) U.S. Cl. 428/41.8; 428/215; 428/203; 428/195.1; 428/332

(57) ABSTRACT

A writing or projection surface, such as may be used for white boards, comprising multiple layers of thin films.

### FIELD OF THE INVENTION

The present invention relates to a multipurpose writing and projection surface utilizing thin films.

### BACKGROUND OF THE INVENTION

Whiteboards, also commonly referred to as a dry erase boards or an erasable marker boards, are known. Initially, whiteboards comprised a dry erase surface that was mounted on a rigid substrate. Accordingly, such products were difficult to transport as they could not be bent when they were shipped. More recently, flexible whiteboards have been developed. See for example US 2006/0024461 (Gustafson et al), which discloses a flexible substrate that can be used to form a pad or roll of dry erase sheets. Gustafson et al discloses a wide range of suitable substrates that may be used, namely polymeric resins, paper based and metal films and sheets.

It is also known to use dry erase boards as projection screens. See for example U.S. Pat. No. 5,361,164 and US2005/0112324 (Rosenbaum et al). As noted in Rosenbaum et al, many of the better performing dry erase surfaces have a high gloss level. This reduces their suitability for use as a projection surface. The gloss level may be reduced by using a roughened surface, such as by embossing or by the introduction of particulate deglossing agents, such as silica and the like. Surface roughing introduces sites that can trap stains and inks, making them more difficult to remove. To overcome this problem, Rosenbaum et al proposed using a dry erase outer surface and a microroughened inner surface.

### SUMMARY OF THE INVENTION

In accordance with the instant invention, a flexible multiuse surface is provided that is suitable for use as a dry erase surface as well as a projection screen. The multiuse surface has a polycarbonate substrate having a thickness of 5 to 20 mil, preferably 10-20 mil and more preferably about 15 mil. This substrate is provided with a suitable dry erase and projection coating. Accordingly, a flexible dry erase and projection surface is provided. An advantage of this invention is that the multiuse surface is self-supporting while also being flexible, such that a screen 54 inches wide by 240 inches long may be rolled up lengthwise and placed in a tube having a diameter of 6 inches for shipping and storage. When removed from the tube and unrolled, the multiuse surface will revert to a flat sheet without any wrinkles, folds or bends in the outer surface. Further, the use of the polycarbonate results in the sheet being self-supporting such that, if it is mounted on a wall, the dry erase and projection layer(s) will not be deformed.

Gustafson et al discloses that the substrate may be, for example, metal. The use of metal, in particular a metal film, is problematic as they are too flexible and may wrinkle or fold. Once this occurs, the dry erase surface is permanently deformed. Accordingly, if mounted on a wall and used as a projection surface, the projection surface may provide an inferior projected image due to the image being distorted by the wrinkles or fold lines. In order to obtain an improved multiuse surface, Rosenbaum et al discloses the use of two layers, a dry erase layer and a microroughened layer. If the layers are impaired during shipment or mounting, then even the use of a microroughened surface will not avoid the impairment of the projected image due to wrinkles or fold lines.

A polyester layer may be provided on the front face of the polycarbonate substrate. Preferably, this polyester layer has a thickness of 3 to 7 mil. More preferably, the polyester layer has a thickness of about 5 mil.

A dry erase and projection surface, which may comprise one or more layers, but preferably comprises a single layer, is provided on the substrate or the optional polyester layer. Preferably, the dry erase and projection surface has a gloss level of 25° to 45, preferably about 30 to about 40°, as measured using a 60° gloss meter.

In accordance with another embodiment of the instant invention, an adhesive layer may be provided on the rear face of the polycarbonate substrate. Optionally, a releasable liner may be disposed on the rear face of the adhesive layer.

In accordance with another embodiment of the instant invention, a printed layer, which may be a printed paper layer, may be positioned between the polyester layer and the polycarbonate substance. In this embodiment, the polyester layer is preferably transparent. Optionally, the printed paper layer may have graphics printed onto the paper material. These graphics may include, but are not limited to, a grid, a sports field, a schedule, a corporate logo and a control board.

### BRIEF DESCRIPTION OF THE DRAWINGS

For a better understanding of the present invention, and to show more clearly how it may be carried into effect, reference will now be made, by way of example, to the accompanying drawings, which show preferred embodiments of the present invention and in which:

FIG. 1 is side elevation view of a writing and projection surface according to one embodiment of the present invention;

FIG. 2 is perspective view of the embodiment of FIG. 1;

FIG. 3 is a side elevation view of an alternative embodiment of the present invention, in which an adhesive layer is provided;

FIG. 4 is a side elevation view of a further alternate embodiment, in which both an adhesive layer and a release liner are provided;

FIG. 5 is a side elevation view of a further alternative embodiment of the present invention, which incorporates a printed paper layer; and,

FIG. 6 is a front view of the embodiment of FIG. 5.

### DESCRIPTION OF THE PREFERRED EMBODIMENT

The present invention provides a writing surface for receiving an image such as may be applied manually by a person writing with a dry erase marker. Accordingly, in one preferred embodiment, the writing surface comprises dry erasable marker board. Examples of such boards include white boards. The writing surface in accordance with the instant invention is also suitable for receiving projected images such as video projection images.

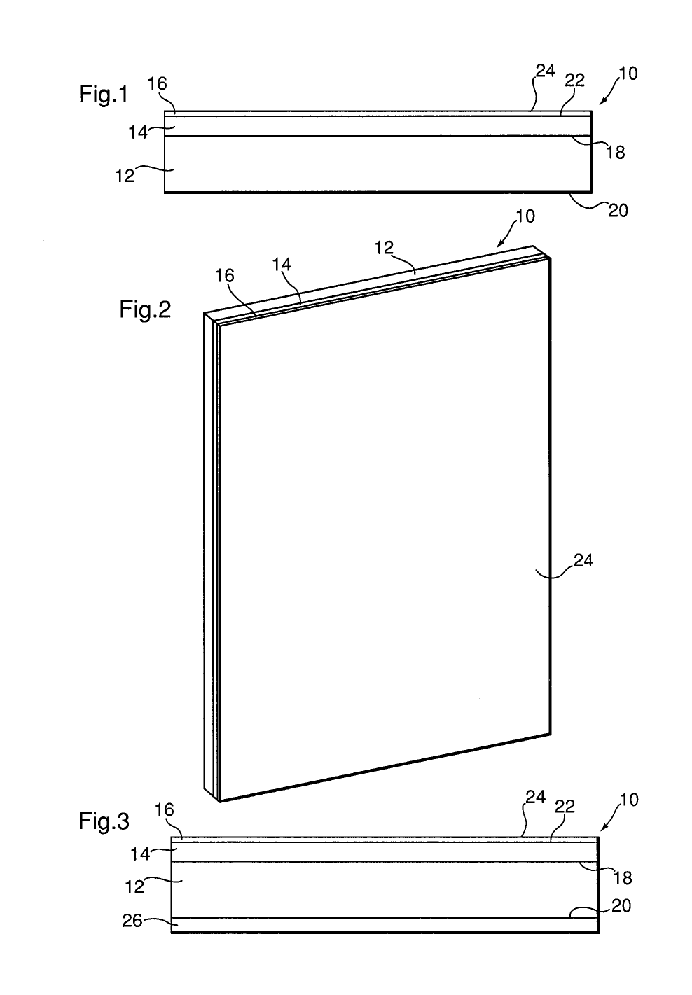

Referring to the embodiment of FIG. 1, a multiuse dry erase writing and projection surface is shown generally at 10. The multiuse surface 10 comprises a polycarbonate substrate 12, a polyester layer 14 with a dry erase coating 16 disposed thereon. Polycarbonate substrate 12 has a front face 18 and a rear face 20. Polyester layer 14 is provided on front face 18 of polycarbonate substrate 12. Dry erase coating 16 is provided on front face 22 of polyester layer 14 and has a front face 24.

Polycarbonate substrate 12 is flexible such that, once a deforming force is removed, the substrate will return to its pre-deformed state. Polycarbonate substrate 12 has a thickness of 5 to 20 mil, more preferably 10 to 20 mil and, most preferably, the polycarbonate substrate has a thickness of about 15 mil. The substrate provides the backing support for the dry erase and projection surface layer or layers and permits the assembly to be self-supporting. Accordingly, when the assembly is being mounted, such as on a wall, the polycarbonate substrate provides sufficient rigidity such that the dry erase and projection surface layer or layers will not fold, bend or otherwise deform, in normal use, and the mounted assembly will be wrinkle free.

The polycarbonate may be any polycarbonate. Preferably, the polycarbonate has a smooth or polished front face 18. Fore example, the polycarbonate may be that sold under the trade mark LEXAN by GE Plastics.

In the embodiment of FIGS. 1 and 2, polyester layer 14 is provided on front face 18 of polycarbonate substrate 12. In this embodiment, polyester layer 14 is preferably white and provides the white appearance of front face 24 of surface 10. It will be appreciated that polyester layer 14 may be an alternate colour, if desired. However, for use as a projection surface, white is preferred. It will also be appreciated that if polycarbonate substrate 12 is white, or a white coating is otherwise applied to front face 18 of polycarbonate substrate 12 such as if a printed layer 32 is used, that polyester layer is preferably clear or may not be used.

Polyester layer 14 may be applied to the polycarbonate substrate 12 by any suitable method such as curtain coating, cascade, rode, brushing, rotogravure and spraying. Non-limiting examples of material that may be used for polyester layer 14 include DuPont's Melinex 329™ and Melinex 339™. Preferably, the polyester layer 14 has a thickness of 3 to 7 mil. More preferably, polyester layer 14 has a thickness of about 5 mil.

In the embodiment of FIG. 1, dry erase coating 16 is provided on front face 22 of polyester layer 14. Dry erase coating 16 may be applied to polyester layer 14 by any means known in the art. Dry erase coating 16 may be one or more layers that, in combination, provide a dry erase writing surface and a surface suitable for use as a projection surface. Preferably, dry erase coating 16 is a single layer.

Dry erase coating 16 may be applied by any method known in the art. For example, dry erase coating 16 may be a sheet that is laminated or otherwise mounted on front face 22 of polyester layer 14. Alternatively, dry erase coating 16 may be adhered to polyester layer 14 by being formed thereon, such as by spray coating or other application techniques known in the art.

A user may write or project an image upon front writing surface 24 of dry erase coating 16. Preferably, the entire area of front writing surface 24 is capable of receiving markings or projected images.

The alternative embodiment of FIG. 3 illustrates the use of adhesive layer 26 disposed on rear face 20 of polycarbonate substrate 12. The adhesive layer allows for multiuse dry erase writing and projection surface 10 to be adhesively fixed to a desired surface, such as wallboard, chalk board, a wall or other preferably rigid structure. Adhesive layer 26 may be selected from any adhesive material suitable for the particular application, including water activated, heat set additives and pressure sensitive adhesives. Preferably, adhesive layer 26 comprises a releasable adhesive, and may be selected from such releasable adhesives as are known in the art.

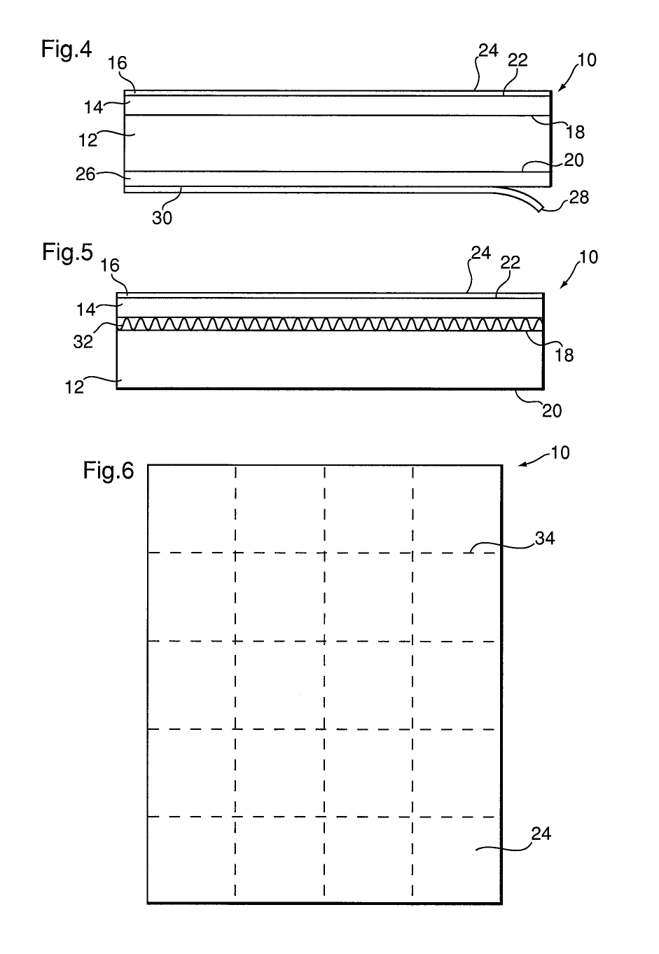

The embodiment of FIG. 4 exemplifies the embodiment of FIG. 3 with release liner 28 optionally provided on rear surface 30 of adhesive layer 26. Release liner 28 is releasable attached to adhesive layer 26 to prevent premature adhesion of surface 10 to unintended surfaces. Release liner 28 may be selected from any low surface energy layer, such as a film or coated paper that are known in the art.

Alternately a fiber backing, which may be from 2 to 5 and preferably about 3 mil think, may be provided on rear surface 20 of polycarbonate substrate 20. This fiber backing may by a non-woven natural cellulose and/or synthetic fiber fabric, and treated with a chemical binder. This fiber backing may be used to secure the substrate to a wall or the like.

The alternative embodiment of FIG. 5 exemplifies the use of printed layer 32 that may be disposed between polyester layer 14 and polycarbonate substrate 12. A variety of graphics may be printed on printed layer 32, including, but not limited to, a grid, sports field, a schedule, a corporate logo and a control board, such as for an industrial plant. It will be appreciated that the graphic may be applied by any means known in the printing arts.

Printed layer 32 can vary in weight, thickness, and composition. Preferably, printed layer comprises paper. Preferably printed layer has a thickness from 1 to 10 mil, more preferably 2 to 5 mil.

It is preferable that when printed layer 32 contains graphics, polyester layer 14, if used, and dry erase coating 16 are transparent such that the graphics are visible to the user.

Printed layer 32 provides a permanent background that may be used by a person writing on front surface 24. As shown in FIG. 6, printed layer 32 has a grid provided thereon. When the user writes or projects an image onto the dry erase coating 16, the gird can be used as an aid for drawing straight lines, enhancing the appearance of a marker drawing or projected image or the like. Similarly, the printed layer could have a sports field, a schedule (e-g., a blank calendar month), a corporate logo or a control board provided thereon. Thus, each surface 10 could be designed for a specific user. An advantage of this design is that the background graphic would not deteriorate as front surface 24 is cleaned to remove dry erase ink. Alternately, the graphic could be provided on front face 18 of polycarbonate substrate 12.

It will be appreciated that surface 10 may be incorporated into any article of commerce that may benefit from incorporating therein an erasable writing surface, such as a wall, cabinet, stand, appliance or the like. The writing surface may be mounted onto solid boards or hollow frames.

It will be appreciated by those skilled in the art that any of the aspects of this invention may be combined in any combination or sub combinations and that not all aspects need not be incorporated into a single embodiment.

1. A multiuse dry erase writing and projection surface comprising:
(a) a polycarbonate substrate having a front face and a rear face and a thickness of 5 to 20 mil;
(b) a polyester layer provided on the front face having a thickness of 3 to 7 mil;
(c) a dry erase coating provided on the polyester layer; and,
(d) an adhesive layer provided on the rear face of the polycarbonate substrate.

2. The multiuse dry erase writing and projection surface of claim 1 wherein the polycarbonate substrate has a thickness of about 10 to 20 mil.

3. The multiuse dry erase writing and projection surface of claim 2 wherein the polyester has a thickness of about 5 mil.

4. The multiuse dry erase writing and projection surface of claim 1 wherein the adhesive comprises a releasable adhesive.

5. The multiuse dry erase writing and projection surface of claim 1 further comprising a release layer applied over the adhesive layer.

6. The multiuse dry erase writing and projection surface of claim 1 further comprising a printed layer positioned between the polyester layer and the dry erase coating and the polyester layer is transparent.

7. The multiuse dry erase writing and projection surface of claim 6 wherein the printed layer has a graphic design on the front face thereof.

8. The multiuse dry erase writing and projection surface of claim 7 wherein the printed layer comprises paper.

9. The multiuse dry erase writing and projection surface of claim 7 wherein the graphic design is selected from the group a grid, a sports field, a control board, a schedule and a corporate logo.

10. The multiuse dry erase writing and projection surface of claim 1 wherein the polycarbonate substrate has a graphic design on the front face thereof.

11. The multiuse dry erase writing and projection surface of claim 1 wherein the dry erase coating has a gloss level of 25° to 45° as measured using a 60° gloss meter.

12. A dry erase whiteboard comprising:
(a) a polycarbonate substrate having a front face and a rear face and a thickness of 5 to 20 mil; and,
(b) a dry erase and projection surface provided on the substrate.

13. The dry erase whiteboard of claim 12 wherein the polycarbonate substrate has a thickness of about 10 to 20 mil.

14. The dry erase whiteboard of claim 12 further comprising a polyester layer provided on the front face and having a thickness of 3 to 7 mil.

15. The dry erase whiteboard of claim 12 wherein the polyester layer has a thickness of about 5 mil.

16. The dry erase whiteboard of claim 12 further comprising an adhesive layer provided on the rear face of the polycarbonate substrate.

17. The dry erase whiteboard of claim 16 wherein the adhesive comprises a releasable adhesive.

18. The dry erase whiteboard of claim 16 further comprising a release layer applied over the adhesive layer.

19. The dry erase whiteboard of claim 12 further comprising a printed layer positioned between the dry erase and projection surface and the polycarbonate layer and the dry erase and projection surface is transparent.

20. The dry erase whiteboard of claim 19 wherein the printed layer has printed thereon a design selected from the group a grid, a sports field, a control board, a schedule and a corporate logo.

21. The dry erase whiteboard of claim 12 wherein the polycarbonate substrate has a graphic design on the front face thereof.

22. The dry erase whiteboard of claim 12 wherein the dry erase and projection surface has a gloss level of 25° to 45° as measured using a 60° gloss meter.
